(19) United States
(12) Patent Application Publication
(10) Pub. No.: US 2005/0041617 A1
(43) Pub. Date: Feb. 24, 2005

(54) Activation of communication sessions in a communication system

(75) Inventors: Seppo Huotari, Espoo (FI); Simo Hyytia, Espoo (FI); Timo Eloranta, Helsinki (FI); Olli Pulkkinen, Espoo (FI); Vimpari Markku, Oulu (FI); Rotsten Kirsi, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/732,214

(22) Filed: Dec. 11, 2003

(30) Foreign Application Priority Data
Aug. 18, 2003 (GB) 0319359.6

(51) Int. Cl. H04L 12/56

(52) U.S. Cl. 370/328; 370/395.2

(57) ABSTRACT

A method in a communication system for providing communication sessions is provided. The method comprises the steps of registering a user equipment with a data network and then registering the user equipment with a service provider by means of the data network. A data session may then be activated between the user equipment and the service provider via a communication network. Subsequent to the activation, a request can be sent from the user equipment to the service provider for a communication session with at least one other party. The already activated data session can be used for communication between the user equipment and the requested at least one other party. A communication system and an application server configured to operate accordingly are also provided.

### BACKGROUND OF THE INVENTION

1. Field of the Invention

The invention relates to communication systems, and in particular to activation of time critical services in communication systems that facilitate packet data communication sessions for users thereof.

2. Description of the Related Art

A communication system can be seen as a facility that enables communication sessions between two or more entities such as user equipment and/or other nodes associated with the communication system. The communication may comprise, for example, communication of voice, data, multimedia and so on. A session may, for example, be a telephone call between users or multi-way conference session, or a communication session between a user equipment and an application server (AS), such as a service provider server. The establishment of these sessions generally enables a user to be provided with various services.

A communication system typically operates in accordance with a given standard or specification which sets out what the various entities associated with the communication system are permitted to do and how that should be achieved. For example, the standard or specification may define if the user, or more precisely, user equipment is provided with a circuit switched service and/or a packet switched service. Communication protocols and/or parameters which shall be used for the connection may also be defined. In other words, a specific set of “rules” on which the communication can be based on needs to be defined to enable communication by means of the system.

Communication systems providing wireless communication for user equipment are known. An example of the wireless systems is the public land mobile network (PLMN). The PLMNs are typically based on cellular technology. In cellular systems, a base transceiver station (BTS) or similar access entity serves wireless user equipment (UE) known also as mobile stations (MS) via a wireless interface between these entities. The communication on the wireless interface between the user equipment and the elements of the communication network can be based on an appropriate communication protocol. The operation of the base station apparatus and other apparatus required for the communication can be controlled by one or several control entities. The various control entities may be interconnected.

One or more gateway nodes may also be provided for connecting the cellular network to other networks e.g. to a public switched telephone network (PSTN) and/or other communication networks such as an IP (Internet Protocol) and/or other packet switched data networks. In such arrangement the mobile communications network provides an access network enabling a user with a wireless user equipment to access external networks, hosts, or services offered by specific service providers. The access point or gateway node of the mobile communication network then provides further access to an external network or an external host. For example, if the requested service is provided by a service provider located in other network, the service request is routed via the gateway to the service provider. The routing may be based on definitions in the mobile subscriber data stored by a mobile network operator.

An example of the services that may be offered for user such as the subscribers to a communication systems is the so called multimedia services. Some of the communication systems enabled to offer multimedia services are known as Internet Protocol (IP) Multimedia networks. IP Multimedia (IM) functionalities can be provided by means of an IP Multimedia Core Network (CN) subsystem, or briefly IP Multimedia subsystem (IMS). The IMS includes various network entities for the provision of the multimedia services. The IMS services are intended to offer, among other services, IP connections between mobile user equipment.

The third generation partnership project (3GPP) has defined use of the general packet radio service (GPRS) for the provision of the IMS services, and therefore this will be used in the following as an example of a possible backbone communication network enabling the IMS services. The exemplifying general packet radio service (GPRS) operation environment comprises one or more sub-network service areas, which are interconnected by a GPRS backbone network. A sub-network comprises a number of packet data service nodes (SN). In this application the service nodes will be referred to as serving GPRS support nodes (SGSN). Each of the SGSNs is connected to at least one mobile communication network, typically to base station systems. The connection is typically by way of radio network controllers (RNC) or other access system controllers such as base stations controllers (BSC) in such a way that packet service can be provided for mobile user equipment via several base stations. The intermediate mobile communication network provides packet-switched data transmission between a support node and mobile user equipment. Different sub-networks are in turn connected to an external data network, e.g. to a public switched data network (PSPDN), via gateway GPRS support nodes (GGSN). The GPRS services thus allow to provide packet data transmission between mobile data terminals and external data networks.

In such a network, a packet data session is established to carry traffic flows over the network. Such a packet data session is often referred as a packet data protocol (PDP) context. A PDP context may include a radio access bearer provided between the user equipment, the radio network controller and the SGSN, and switched packet data channels provided between the serving GPRS support node and the gateway GPRS support node.

A data communication session between the user equipment and other party would then be carried on the established PDP context. Each PDP context can carry more than one traffic flow, but all traffic flows within one particular PDP context are treated the same way as regards their transmission across the network. The PDP context treatment requirement is based on PDP context treatment attributes associated with the traffic flows, for example quality of service and/or charging attributes.

The Third Generation Partnership Project (3GPP) has also defined a reference architecture for the third generation (3G) core network which will provide the users of user equipment with access to the multimedia services. This core network is divided into three principal domains. These are the Circuit Switched (CS) domain, the Packet Switched (PS) domain and the Internet Protocol Multimedia (IM) domain. The latter of these, the IM domain, is for ensuring that multimedia services are adequately managed.

The IM domain supports the Session Initiation Protocol (SIP) as developed by the Internet Engineering Task Force (IETF). Session Initiation Protocol (SIP) is an application-layer control protocol for creating, modifying and terminating sessions with one or more participants (endpoints). SIP was generally developed to allow for initiating a session between two or more endpoints in the Internet by making these endpoints aware of the session semantics. A user connected to a SIP based communication system may communicate with various entities of the communication system based on standardised SIP messages. User equipment or users that run certain applications on the user equipment are registered with the SIP backbone so that an invitation to a particular session can be correctly delivered to these endpoints. To achieve this, SIP provides a registration mechanism for devices and users, and it applies mechanisms such as location servers and registrars to route the session invitations appropriately. Examples of the possible sessions that may be provided by means of SIP signalling include Internet multimedia conferences, Internet telephone calls, and multimedia distribution.

It is expected that various types of services are to be provided by means of different Application Servers (AS) over IMS systems. Some of these services may be time critical. An example of the time-critical services that may be provided over the IMS are the so called direct voice communication services. A more specific example of these is the “Push-to-talk over Cellular” (PoC) service, also known as PTT, Push-To-Talk service. The direct voice communication services are intended to use the capabilities of the IP Multimedia Subsystem (IMS) for enabling IP connections for mobile user equipment and other parties of the communications, for example other mobile user equipment or entities associated with the network. The service allows the users to engage in immediate communication with one or more receivers.

In PoC services communication between a user equipment and a PoC application server occurs on a one-way communications media. A user may open the communications media by simply pushing a tangent key, for example a button on the keyboard of a user equipment. The push to talk button may be a specific button or then any appropriate key of the keyboard. While a user speaks, the other user or users may listen. Bi-directional communication can be offered since all parties of the communications session may similarly communicate voice data with the PoC application server. The turns to speak are requested by pressing the push-to-talk button. The turns may be granted for example on a first come first served basis or based on priorities. Users can join the group session they wish to talk to and then press the tangent key to start talking.

The push-to-talk instant services are real-time services by their nature. Therefore the user plane connection should be ready to use almost immediately after the special tangent or other “PoC” key is pressed in order to speak. However, due to the nature of the set-up procedures required for a PDP context, it may take a while until a user is actually provided with a proper data connection from the request to have one. For example, the attachment to a PoC group in one-to-many communications and PoC communication between two user equipment (one-to-one communications) requires an SIP session on the control plane.

For example, the PDP context activation together with radio access bearer establishment time in 3GPP release 5 compliant IMS network takes typically longer than three seconds. This might be too long for setting up the session and user plane connection for push-to-talk type communications within an acceptable time frame. The inventors estimate that especially if the waiting time is longer than the above referred three seconds, it is likely that the calling party may become frustrated and decide not to wait any longer. A waiting time for more than three seconds might also be considered by the network operators as inadequate from the service level point of view.

If the caller has not received the start-to-talk-indication in three seconds, he/she might even assume that the request for call session was not successful. The caller may then repress the tangent. The repressing causes a new session establishment procedure wit the required signalling, thus consuming network resources and delaying the session set-up further. This might become a problem particularly in one-to-one communications.

To avoid the above problems, it might be advantageous to be able to provide a mechanism for time critical service applications by means of which the session set-up could occur in a substantially short period of time.

### SUMMARY OF THE INVENTION

According to one embodiment of the invention, there is provided a method in a communication system for providing communication sessions. The method comprises the steps of registering a user equipment with a data network, registering the user equipment with a service provider by means of the data network, activating a data session between the user equipment and the service provider via a communication network, sending a request from the user equipment to the service provider for a communication session with at least one other party, and using the already activated data session for communication between the user equipment and the requested at least one other party.

According to another embodiment of the invention there is provided a communication system configured for providing services for users thereof. The communication system comprises a communication network for providing user equipment with access to at least one data network, a data network connected to the communication network and provided with a controller, the controller being configured to accept registrations by the user equipment, and an application server connected to the data network. The application server is configured to accept registrations of user equipment registered with the controller. The communication system is configured such that a data session can be activated between a user equipment registered with the application server and the application server via the communication network before a request for a communication session with at least one other party is sent from the user equipment to the application server. The already activated data session can then be used for communication between the user equipment and the requested at least one other party.

According to yet another embodiment of the invention there is provided an application server configured for connection to a data network and for providing services for user equipment connected to a communication network. The application server is configured to accept registrations of user equipment registered with the data network, to facilitate activation of a data session between the application server and a user equipment registered with the application server and the data network via the communication network before a request for a communication session with at least one other party is sent from the user equipment to the application server, and to use, in response to a request for a data session, the already activated data session for communication between the user equipment and the requested at least one other party.

The embodiments of the invention may provide advantage in that the time which is required for setting up a speech or other session for a user can be decreased. This may be especially advantageous in time critical service applications. The embodiments may improve the usability of services, especially time critical services.

### BRIEF DESCRIPTION OF THE DRAWINGS

For better understanding of the invention, reference will now be made by way of example to the accompanying drawings in which:

FIG. 1 shows a communication system wherein the invention may be embodied;

FIG. 2 is a flowchart illustrating the operation of one embodiment of the invention;

FIG. 3 shows a possible PDP context activation procedure;

FIG. 4 shows a possible assignment of radio access bearers; and

FIG. 5 shows sending of a request for registration with a time critical service.

### DETAILED DESCRIPTION OF THE PREFERRED EMBODIMENTS

Certain embodiments of the present invention will be described by way of example, with reference to the exemplifying architecture of a third generation (3G) mobile communications system. However, it will be understood that certain embodiments may be applied to any other suitable form of network. A mobile communication system is typically arranged to serve a plurality of mobile user equipment usually via a wireless interface between the user equipment and base station of the communication system. The mobile communication system may logically be divided between a radio access network (RAN) and a core network (CN).

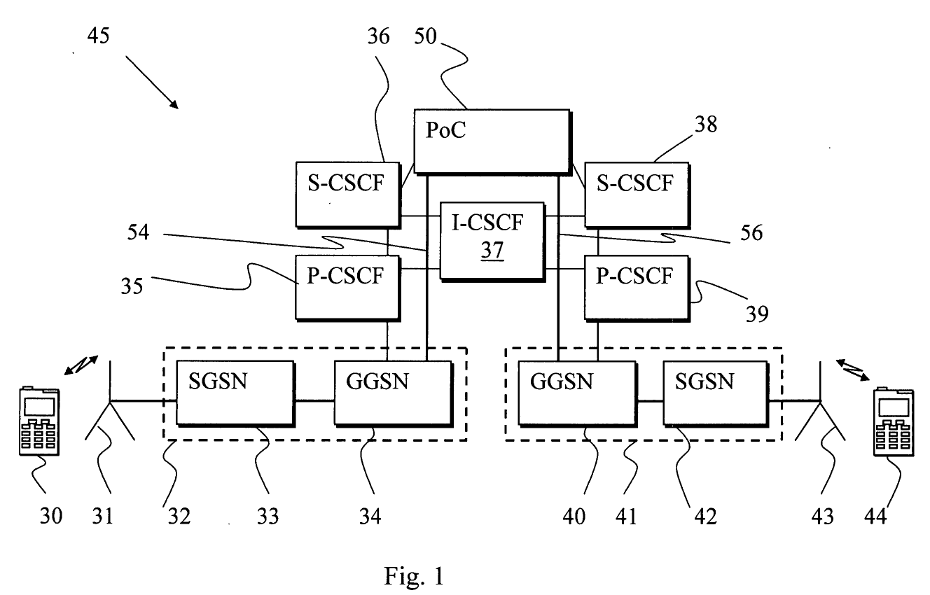

Reference is made to FIG. 1 which shows an example of a network architecture wherein the invention may be embodied. FIG. 1 shows an IP Multimedia Network 45 for offering IP multimedia services for IP Multimedia Network subscribers. IP Multimedia (IM) functionalities can be provided by means of a Core Network (CN) subsystem including various entities for the provision of the service.

Base stations 31 and 43 are arranged to transmit signals to and receive signals from mobile user equipment 30 and 44 of mobile users i.e. subscribers via respective wireless interfaces. Correspondingly, each of the mobile user equipment is able to transmit signals to and receive signals from the base stations via the wireless interface. In the simplified presentation of FIG. 1, the base stations 31 and 43 belong to the respective radio access networks (RAN). In the shown arrangement each of the user equipment 30, 44 may access the IMS network 45 via the two access networks associated with base stations 31 and 43, respectively. It shall be appreciated that, although, for clarity, FIG. 1 shows the base stations of two radio access networks, a typical mobile communication network usually includes a number of radio access networks.

The 3G radio access network (RAN) is typically controlled by appropriate radio network controller (RNC). This controller is not shown in order to enhance clarity. A controller may be assigned for each base station or a controller can control a plurality of base stations. Solutions wherein controllers are provided both in individual base stations and in the radio access network level for controlling a plurality of base stations are also known. It shall thus be appreciated that the name, location and number of the network controllers depends on the system.

A user equipment within the radio access network may communicate with a radio network controller via radio network channels which are typically referred to as radio bearers (RB). Each user equipment may have one or more radio network channel open at any one time with the radio network controller.

The mobile user may use any appropriate mobile device adapted for Internet Protocol (IP) communication to connect the network. For example, the mobile user may access the cellular network by means of a Personal computer (PC), Personal Data Assistant (PDA), mobile station (MS) and so on. The following examples are described in the context of mobile stations.

One skilled in the art is familiar with the features and operation of a typical mobile station. Thus, a detailed explanation of these features is not necessary. It is sufficient to note that the user may use a mobile station for tasks such as for making and receiving phone calls, for receiving and sending data from and to the network and for experiencing e.g. multimedia content. A mobile station is typically provided with processor and memory means for accomplishing these tasks. A mobile station may include antenna means for wirelessly receiving and transmitting signals from and to base stations of the mobile communication network. A mobile station may also be provided with a display for displaying images and other graphical information for the user of the mobile user equipment. Speaker means may are also be provided. The operation of a mobile station may be controlled by means of an appropriate user interface such as control buttons, voice commands and so on.

The mobile stations 30 and 44 are enabled to use of the Push-to-talk type services. A tangent function that may be required by the Push-to-talk services can be provided by one of the buttons on the normal keypad of the mobile stations 30 and 44, or by a specific tangent key, for example with a tangent known from the “Walkie-Talkie” devices. Voice activation may also be used. In this case a detected sound may be used for triggering the set-up of the session for transmission of speech or other data. Instead of pressing a key, the user may also activate the service by means of an appropriate menu selection. The manner how a mobile station may activate the service is an implementation issue, and will therefore not be described in any more detail.

It shall be appreciated that although only two mobile stations are shown in FIG. 1 for clarity, a number of mobile stations may be in simultaneous communication with each base station of the mobile communication system. A mobile station may also have several simultaneous sessions, for example a number of SIP sessions and activated PDP contexts. The user may also have a phone call and be simultaneously connected to at least one other service.

The core network (CN) entities typically include various control entities and gateways for enabling the communication via a number of radio access networks and also for interfacing a single communication system with one or more communication system such as with other cellular systems and/or fixed line communication systems. In FIG. 1 serving GPRS support nodes 33, 42 and gateway GPRS support nodes 34, 40 are for provision of support for GPRS services 32, 41, respectively, in the network.

The radio access network controller is typically connected to an appropriate core network entity or entities such as, but not limited to, the serving general packet radio service support nodes (SGSN) 33 and 42. The radio access network controller is in communication with the serving GPRS support node via an appropriate interface, for example on an Iu interface. Although not shown, each SGSN typically has access to designated subscriber database configured for storing information associated with the subscription of the respective user equipment. The serving GPRS support node 33, in turn, may communicate with a gateway GPRS support node 34 via the GPRS backbone network 32. This interface is commonly a switched packet data interface.

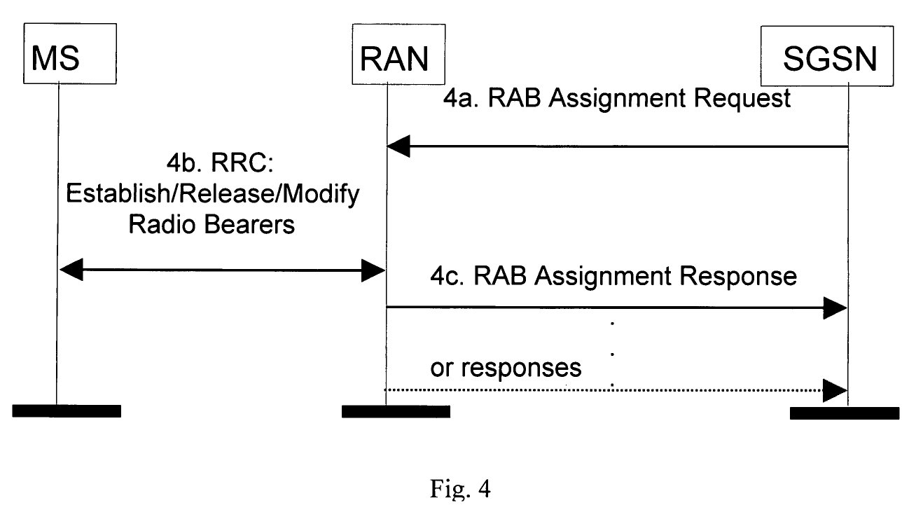

Overall communication between user equipment in an access entity and a gateway GPRS support node is generally provided by a packet data protocol (PDP) context. Each PDP context usually provides a communication pathway between a particular user equipment and the gateway GPRS support node and, once established, can typically carry multiple flows. Each flow normally represents, for example, a particular service and/or a media component of a particular service. The PDP context therefore often represents a logical communication pathway for one or more flow across the network. To implement the PDP context between user equipment and the serving GPRS support node, radio access bearers (RAB) need to be established which commonly allow for data transfer for the user equipment. The implementation of these logical and physical channels is known to those skilled in the art and is therefore not discussed further herein. An example of assignment of radio bearer to a mobile station is shown in FIG. 4.

The user equipment 30, 44 may connect, via the GPRS network, to application servers that are generally connected to the IMS. In FIG. 1 such an application server is provided by a push-to-talk over cellular (PoC) services server 50. The PoC application server is for providing push-to-talk over cellular (PoC) services over the IMS network 45. The push-to-talk service is an example of the so called direct voice communication services. Users who wish to use the PoC service may need to subscribe to an appropriate PoC server. The registration to the PoC service after the registration to the IMS may then be done by the IMS by means of appropriate third party registration procedure.

The direct voice communication services are intended to use the capabilities of the GPRS backbone and the control functions of the Multimedia Subsystem (IMS) for enabling IP connections for the mobile stations 30 and 44. The PoC servers may be operated by the operator of the IMS system, or by a third party service provider. A more detailed explanation of how the service allows the user of the mobile station 30 to engage in immediate communication with the user of the mobile station 44 is given later in this description.

A user may open the communication session, for example by simply pressing a specific button on the mobile station 30. While the user of the mobile station 30 speaks, the user of the mobile station 44 listens. The user of the mobile station 44 may then reply in similar manner.

The communication systems have developed such that services may be provided for the user equipment by means of various functions of the network that are handled by network entities known as servers. For example, in the current third generation (3G) wireless multimedia network architectures it is assumed that several different servers are used for handling different functions. These include functions such as the call session control functions (CSCFs). The call session control functions may be divided into various categories such as a proxy call session control function (P-CSCF), interrogating call session control function (I-CSCF), and serving call session control function (S-CSCF).

It shall be appreciated that similar function may be referred to in different systems with different names. For example, in certain applications the CSCFs may be referenced to as the call state control functions.

Communication systems may be arranged such that a user who has been provided with required communication resources by the backbone network has to initiate the use of services by sending a request for the desired service over the communication system. For example, a user may request for a session, transaction or other type of communications from an appropriate network entity. Furthermore, the user needs to register his/hers user equipment in a serving control entity of the IMS. The registration is typically done by sending a user identity to the serving control entity. From the above discussed exemplifying network entities the serving call session control function (S-CSCF) forms in the 3G IMS arrangements the entity a user needs to be registered with in order to be able to request for a service by means of the IMS system.

The signaling between the user equipment and the appropriate call state control functions is routed via the GPRS networks. The user plane session set-up signaling for the user equipment 30 is routed via and controlled by the PoC application server 50, i.e. the PoC controls both the control plane and the user plane of the PoC user. It shall be appreciated that the control plane traffic between the PoC application server and the user equipment is routed via the IMS 45 while the user plane traffic between the user equipment and the PoC application server is routed from the GPRS system to the PoC application server on interfaces 54 and 56.

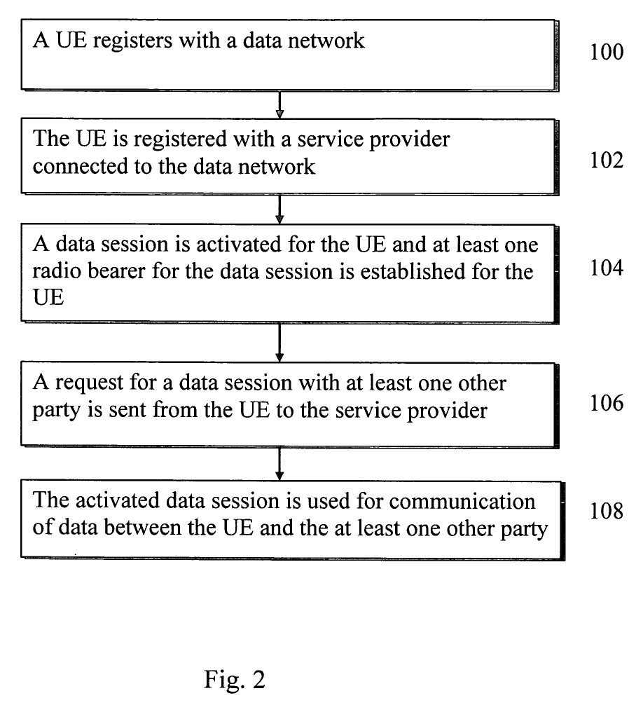

In accordance with an embodiment the mobile station 30 is provided with initial registration with the IMS at step 100 of FIG. 2. The user equipment may register, for example, to the serving CSCF 36 of the IMS.

The user equipment 30 is then registered with the PoC application server at step 102. The registration at step 102 may occur substantially soon after the registration with the IMS at step 100. For example, after the mobile station 30 is successfully registered with the IMS, a third party registration may be automatically carried out with the PoC application server 50 at step 102. The third party registration may be performed by means of a SIP third party registration procedure between the IMS and the PoC application server. This may be done for each user who has subscribed to the PoC services. Thus the user may not need to take any action at this stage. Alternatively, the user or any other party may trigger the registration at any stage after the mobile station is registered with the IMS.

After successful registration at the PoC application server, the user equipment may request for establishment of an “always on” session with the PoC application server at step 104. This step includes activation of the PDP context for the user and set-up of required radio access bearers (RAB). This may also occur automatically after registration with the PoC application server at step 102. This pre-establishment procedure may be called for example as a “pre-session”, “early session” or “always-on session” establishment. The pre-establishment is performed in order to facilitate a quick session set-up in response to the user sending a request for a communication session, for example by pressing the tangent key of the user equipment. The pre-establishment of the PDP context may be performed by means of an SIP session for activating the PDP context.

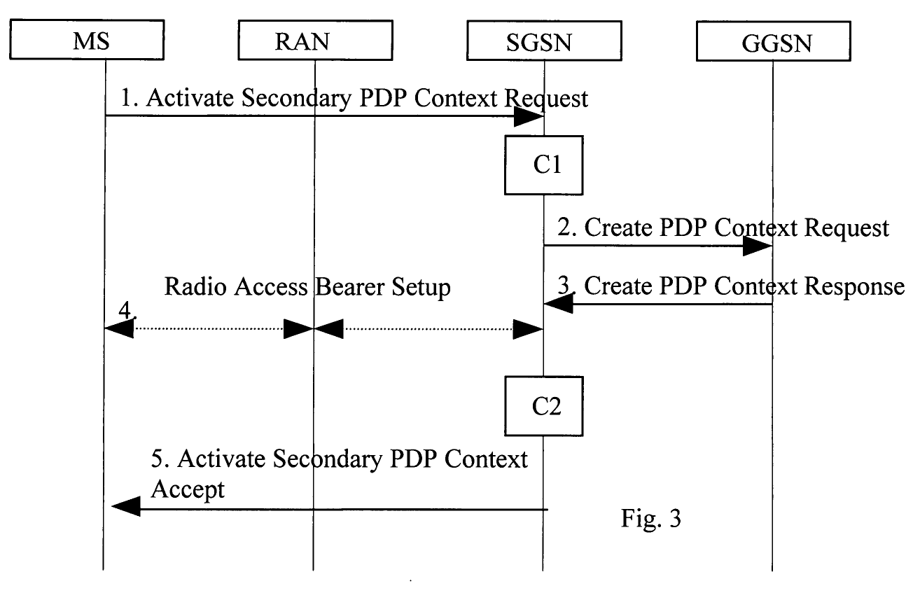

A standard PDP-context activation procedure that may be used in the embodiment is shown in FIG. 3. The activation may comprise sending of a SIP message 1 from the mobile station requesting for activation of a PDP context. FIG. 3 refers to secondary activation since it might be necessary in certain applications to activate the primary PDP context for enabling the sending of SIP messages.

As shown by FIG. 3, message 1 may be routed via the radio access network to the SGSN 33 where appropriate control operations may follow at step C1. Message 1 may be a SIP INVITE message. The SGSN 33 then sends message 2 requesting for creation of the PDP context to the GGSN 34. The GGSN responds the request by message 3. If everything is in order, the SGSN 33 then initiates the radio access bearer set-up at messaging step 4 for the establishment of the data bearers. Certain protocols may require security procedures such as authorisation between message steps 2 and 3 before the GGSN responds the request.

The radio access bearer (RAB) setup may be done by means of an appropriate RAB assignment procedure. The RAB assignment procedure is typically for enabling establishment of new RABs for a given mobile station and/or modification and/or release of already established RABs. FIG. 4 shows an example of such assignment. The exemplifying assignment operation comprises sending of message 4a from the SGSN to the radio access network requesting for an assignment of at least one RAB. The radio access network may then establish the requested radio bearers at step 4b. At messaging step 4c the radio access network sends at least one RAB assignment response message to the SGSN.

After the required radio access bearers have been set up, the SGSN may do some further control operations at step C2, and then send a response message 5 to the mobile station 30 confirming that the request of message 1 is accepted.

The two mechanisms as described above and shown in FIGS. 3 and 4 can be used for establishing a 3G session. However, use of these mechanisms might take too much time for time critical services such as the PoC services. Therefore, in order to provide adequate instant services for a user, an “always-on” session is provided between the mobile station 30 and the PoC server 50 before any actual request for speech session is made at step 106. The already established communication session may then be used for communication at step 108 of FIG. 2.

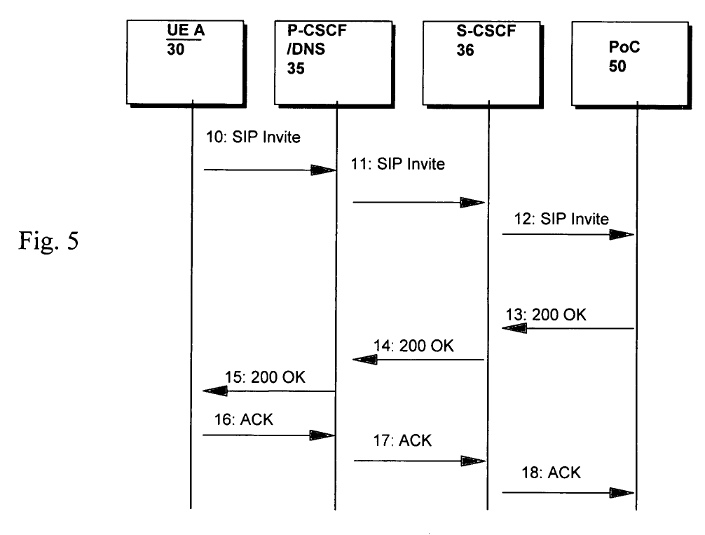

FIG. 5 shows an embodiment for activation of a pre-established data session between a mobile station 30 and a PoC application server 50. The pre-session activation may be initiated by sending an appropriate message to the PoC application server 50 after completion of the steps of registering the mobile station with the IMS and the third party registration of the mobile station with the PoC application server. In the example of FIG. 5 the pre-session activation request is sent from the mobile station 30 as a SIP INVITE message 10. The routing of the INVITE message via the possible proxy and serving CSCFs can be based on a PoC-specific indication in the message. The PoC server receives the SIP INVITE message 12 and responds the INVITE message by SIP 200 OK message 13. The SIP 200 OK message is then routed back to the mobile station 30. Upon receipt of the OK message 15, the mobile station may acknowledge the receipt thereof by sending SIP ACK message 16 to be routed to the PoC application server 50. The “always-on” is now activated and ready for use for communication between the user equipment 30 and the PoC 50. It is not necessary to indicate the possible B-party to the PoC server at this stage.

The mobile station 30 may send the pre-session request 10 automatically after a successful registration procedure with the IMS 45 and the PoC application server 50. In this case the SIP 200 OK response to a registration request may act as a trigger.

According to a possibility the PoC application server rather than the mobile station activates the PDP context between the PoC application server and the mobile station. The activation may occur in response to a completed registration of a mobile station with the PoC application server. In this case the application server may make a pre-INVITE request. Automatic triggering at the PoC application server may also occur when the PoC application server receives a request from a user who is already registered with the application server but for reason or another does not have an active pre-session. The PoC application server may also initiate the pre-session establishment towards the B-party.

Activation of the session may also be needed later on. For example, an established pre-session may become released for some reason before deregistration of the user. Thus the mobile station 30 may need to create a new pre-session in order to speed up the communication session set-up. In this case the user may, for example, select a service activation option from the menu of the mobile station for triggering the sending of a pre-INVITE message.

The pre-established “always-on” session provides substantially instant communication between the end user and his/hers home PoC application server. The communication may be transported from the mobile station 30 to the PoC application server in response the user of the mobile station 30 pressing the tangent key of the mobile station wherein the pressing of the tangent opens a speech connection to the PoC server. Since the PDP-context is already established, the communication request can be transported to the PoC application server by means of any appropriate signalling protocol.

It shall be appreciated that this is an application level issue, and can be provided in various manners. The communication network standards, such as the 3GPP, are typically not set restricted in a particular protocol for this type of purposes. To give an example, Real-time transport protocol (RTP) or RTP control protocol (RTCP) may be used for the sending of the request. These protocols may be used together or separately. The request may also be sent by means of SIP. The packets may be transported based on, for example, the User Datagram Protocol (UDP) or Transport Control Protocol (TCP).

The “always on” session enables the mobile station to know to which IP address and port of the PoC application server the RTP/RTCP packets shall be sent. RTP/RTCP payload includes sufficient addressing information for routing of the RTP/RTCP packets to the B-party mobile station 44.

The B-party needs to be identified for the PoC application server at this stage. The user may select the B-party user or target group from the menu of the mobile station, and then press the “push to talk” key on the mobile station. The required identity information is then added by the mobile station to the signalling on the “always on” session to the PoC server.

If the B-party mobile station 44 is not registered in the PoC service, user of the A-party mobile station 30 may receive an error message.

The pre-session establishment may substantially speed-up the session establishment since the PDP activation, media authorization and RAB assignment procedures are already done before the user gives an indication that he/she wants to talk. The communication may happen instantly without steps of dialing, call setup, ringing or answering. In addition to shortening the set-up time, the embodiments may offer terminal manufacturers an opportunity to implement the push-to-talk facility across mobile phone categories, thus offering end-users more freedom to choose products that best meet their communication needs.

It shall be appreciated that although FIG. 1 shows and the above describes only one PoC application server, a number of such servers may be provided. The A- and B-party user equipment may be registered with different PoC application servers. The applications servers serving the A- and B-parties may even be located in different networks.

The above describes a general application server based solution for a time critical service like the PoC. However, it shall be appreciated that the invention may be applied to other services without departing from the spirit and scope thereof.

It should be appreciated that while embodiments of the invention have been described in relation to mobile stations, embodiments of the invention are applicable to any other suitable type of user equipment.

The examples of the invention have been described in the context of an IMS system and GPRS networks. This invention is also applicable to any other access techniques. Furthermore, the given examples are described in the context of SIP networks with SIP capable entities. This invention is also applicable to any other appropriate communication systems, either wireless or fixed line systems and standards and protocols.

The embodiments of the invention have been discussed in the context of call state control functions. Embodiments of the invention can be applicable to other network elements where applicable.

It is also noted herein that while the above describes exemplifying embodiments of the invention, there are several variations and modifications which may be made to the disclosed solution without departing from the scope of the invention as defined in the appended claims.

1. A method in a communication system for providing communication sessions, the method comprising:
registering a user equipment with a data network;
registering the user equipment with a service provider by means of the data network;
activating a data session between the user equipment and the service provider via a communication network;
sending a request from the user equipment to the service provider for a communication session with at least one other party; and
using an already activated data session for communications between the user equipment and a requested at least one other party.

2. A method as claimed in claim 1, wherein the step of registering the user equipment with a service provider comprises registering the user equipment with a push-to-talk service application server.

3. A method as claimed in claim 1, further comprising:
sending at least one Session Initiation Protocol message.

4. A method as claimed in claim 3, wherein the step of sending comprises sending said at least one Session Initiation message comprising a Session Initiation Protocol INVITE message.

5. A method as claimed in claim 1, wherein the step of registering the user equipment with the data network comprises registering the user equipment with an Internet Protocol Multimedia subsystem.

6. A method as claimed in claim 5, wherein the step of registering comprises registering the user equipment with a serving controller of the Internet Protocol Multimedia subsystem.

7. A method as claimed in claim 1, wherein the step of registering the user equipment with the service provider comprises automatically registering the user equipment with the service provider in response to registering the user equipment with the data network.

8. A method as claimed in claim 1, wherein the step of registering the user equipment with the service provider comprises a third party registration of the user equipment by the data network.

9. A method as claimed in claim 1, wherein the step of activating comprises activating the data session via the communication network comprising a General Packet Radio Service network.

10. A method as claimed in claim 1, wherein the step of activating comprises activating the data session comprising a Packet Data Protocol context.

11. A method as claimed in claim 1, further comprising:
opening a substantially instant user plane communication session between the user equipment and the service provider in response to actuating a tangent key of the user equipment.

12. A communication system configured for providing services for users of said communication system, the communication system comprising:
a communication network for providing user equipment with access to at least one data network;
a data network connected to the communication network and provided with a controller, the controller being configured to accept registrations by the user equipment;
an application server connected to the data network, the application server being configured to accept the registrations of the user equipment registered with the controller, wherein a communication system is configured such that a data session can be activated between a user equipment registered with the application server and the application server via the communication network before a request for a communication session with at least one other party is sent from the user equipment to the application server, and such that an already activated data session can then be used for communications between the user equipment and a requested at least one other party.

13. A communication system as claimed in claim 12, wherein the application server comprises a push-to-talk service application server, the data network comprises an Internet Protocol Multimedia subsystem, and the communication network comprises a packet switched communication network.

14. A communication system as claimed in claim 12, wherein the data network comprises a controller configured to enable the user equipment to register with the data network, the communication system being configured such that subsequent to registering with the controller, the user equipment is automatically registered with the application server.

15. A communication system as claimed in claim 14, the communication system being configured to automatically send a pre-session request subsequent to registering the user equipment with the application server.

16. A communication system as claimed in claim 12, wherein the communication network comprises a General Packet Radio Service network.

17. An application server configured for connecting to a data network and for providing services for user equipment connected to a communication network, the application server being configured to accept registrations of user equipment registered with the data network, to facilitate activation of a data session between the application server and a user equipment registered with the application server and the data network via the communication network before a request for a communication session with at least one other party is sent from the user equipment to the application server, and to use, in response to a request for a data session, an already activated data session for communications between the user equipment and a requested at least one other party.

18. An application server as claimed in claim 17, the application server further comprising a push-to-talk service application server.

19. An application server as claimed in claim 17, the application server being configured for connecting to an Internet Protocol Multimedia subsystem.

20. A communication system for providing services for users of said communication system, the communication system comprising:
first registering means for registering a user equipment with a data network;
second registering means for registering the user equipment with a service provider by means of the data network;
activating means for activating a data session between the user equipment and the service provider via a communication network;
sending means for sending a request from the user equipment to the service provider for a communication session with at least one other party; and
using means for using an already activated data session for communications between the user equipment and a requested at least one other party.
